(19) United States
(12) Patent Application Publication
(10) Pub. No.: US 2016/0008994 A1
(43) Pub. Date: Jan. 14, 2016

(54) ERGONOMIC HAIR CUTTING TOOLS

(71) Applicant: Alvincent JOHNSON, Pittsburg, CA (US)

(72) Inventor: Alvincent JOHNSON, Pittsburg, CA (US)

(21) Appl. No.: 14/329,822

(22) Filed: Jul. 11, 2014

(51) Int. Cl. B26B 19/38; B26B 19/02

(52) U.S. Cl. CPC B26B 19/3853; B26B 19/02

(57) ABSTRACT

An electric hair clipper ergonomically configured to improve user comfort and improve performance is disclosed. For example, the electric hair clipper can be configured to receive one or more removable weights for adjusting the total weight and balance of the clipper. In other examples, the electric hair clipper can include a hand grip and finger rests for comfort and precision. In other examples, a removable sleeve can be used with the electric hair clipper to reduce vibrations, provide isolation against heat, and provide a comfortable grip for a barber.

### FIELD OF THE DISCLOSURE

This relates generally to hair cutting tools and, more specifically, to ergonomic hair cutting tools with improved performance.

### BACKGROUND OF THE DISCLOSURE

Many types of tools are presently available for cutting hair, such as electric powered hair clippers and trimmers. Electric clippers and trimmers can use a motor powered by batteries or an external power source to control blades to cut hair. Typical electric hair clippers and trimmers, however, are designed without much consideration for the individual needs of the barber or stylist using the tools. For example, the housing of electric clippers or trimmers can become uncomfortably hot from extended use. In other examples, the housing of the clippers or trimmers can be manufactured from uncomfortable materials or without proper grips which can cause discomfort and fatigue and produce inconsistent hair cutting results. In other examples, barbers or stylists may have to use a clipper or trimmer with a different weight than they are accustomed to, which can cause discomfort and reduce performance. Similarly, vibrations from an electric motor can cause discomfort and reduce performance.

### SUMMARY OF THE DISCLOSURE

This relates to an electric hair clipper ergonomically configured to improve user comfort and improve performance. For example, the electric hair clipper can include a motor, blades, and a housing with one or more recesses formed in the housing. The recesses can be configured to receive one or more removable weights for adjusting the total weight and balance of the clipper. Additionally or alternatively, in some examples, the electric hair clipper can have power supplied by a power cord and a recess can be located in a proximal portion of the housing proximate to the power cord. Additionally or alternatively, in some examples, the electric hair clipper can include a recess at a distal portion of the housing. Additionally or alternatively, in some examples, the weight can be inserted into the recess of the housing and coupled magnetically by forming the weight and/or the housing at least partially of magnetic substances. Additionally or alternatively, in some examples, the housing can include a removable cover over the recess to secure the weight.

This also relates to an electric hair clipper including a hand grip and finger rests for comfort and precision. The hair clipper can include a motor, blades, and a housing having one or more grooves formed in the housing as finger rests. Additionally or alternatively, in some examples, the hair clipper can have two grooves located on opposite sides of the apparatus. Additionally or alternatively, in some examples, the hair clipper can have two grooves located on the top and bottom of the hair clipper. Additionally or alternatively, in some examples, the hair clipper can have a rubber material disposed on the surface of the housing over one or more grooves. Additionally or alternatively, in some examples, middle portion of the hair clipper housing can include one or more ridges and a plurality of valleys. Additionally or alternatively, in some examples, the middle portion of the hair clipper can be formed at least partially of a rubber material.

This also relates to a removable sleeve that can be used with the electric hair clipper to reduce vibrations, provide insulation against heat, and provide a comfortable grip for a barber. The removable sleeve can include a body comprising an exterior surface and an interior surface and a zipper. The interior surface can be configured for contacting an exterior of a housing of the electric hair clipper. The zipper can be coupled to the body and configured to increase an area of the interior surface of the body in contact with the exterior of the housing of the hair clipper in a closed position and decrease the area of the interior surface of the body in contact with the exterior of the housing in an open position. Additionally or alternatively, in some examples, the body of the sleeve can be formed of elastic material. Additionally or alternatively, in some examples, the interior surface of the sleeve can be made of a rubber material. Additionally or alternatively, in some examples, the zipper is in the closed position, the body comprises at least one opening for a blade assembly of the hair clipper, the at least one opening circumscribing the housing of the hair clipper. Additionally or alternatively, in some examples, the body can include at least one opening for a power cord. Additionally or alternatively, in some examples, the sleeve can include one or more pouches for receiving gel packs. Additionally or alternatively, in some examples, the one or more pouches have an opening for removing or replacing a gel pack.

### BRIEF DESCRIPTION OF THE DRAWINGS

FIG. 1 illustrates an exemplary electric hair clipper according to examples of the disclosure.

FIG. 2 illustrates an exemplary electric hair clipper with an adjustable weight according to examples of the disclosure.

FIG. 3 illustrates an exemplary electric hair clipper with multiple adjustable weights according to examples of the disclosure.

FIGS. 4A and 4B illustrate exemplary views of an electric hair clipper with hand and finger grips according to examples of the disclosure.

FIG. 5 illustrates an exemplary electric hair clipper with a hand grip and thumb rest according to examples of the disclosure.

FIG. 6 illustrates an exemplary electric hair clipper according to examples of the disclosure

FIG. 7 illustrates an exemplary removable clipper sleeve according to examples of the disclosure.

FIGS. 8A and 8B illustrate exemplary composite weights according to examples of the disclosure.

FIG. 8C illustrates an exemplary weight with a protrusion according to examples of the disclosure.

FIG. 8D illustrates an exemplary weight with a depression according to examples of the disclosure.

### DETAILED DESCRIPTION OF THE PREFERRED EXAMPLES

In the following description of preferred examples, reference is made to the accompanying drawings which form a part hereof, and in which it is shown by way of illustration specific examples in which the disclosure can be practiced. It is to be understood that other examples can be used and structural changes can be made without departing from the scope of the examples of this disclosure.

This relates to an electric hair clipper ergonomically configured to improve user comfort and improve performance. For example, the electric hair clipper can be configured to receive one or more removable weights for adjusting the total weight and balance of the clipper. In other examples, the electric hair clipper can include a hand grip and finger rests for comfort and precision. In other examples, a removable sleeve can be used with the electric hair clipper to reduce vibrations, provide isolation against heat, and provide a comfortable grip for a barber.

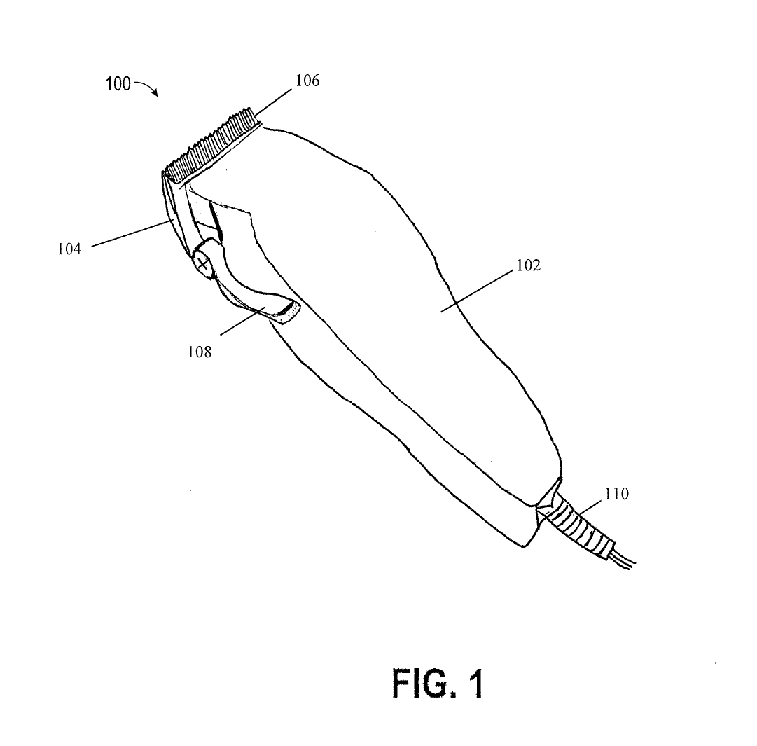

FIG. 1 illustrates an exemplary electric hair clipper 100 according to examples of the disclosure. Electric hair clipper 100 can have a housing 102 and a blade assembly 104. The housing 102 can be made of plastic or any other suitable material. The blade assembly 104 can include two or more blades 106 which can move relative to one another to cut hair. The blades 106 can be operated by an electric motor located within the housing 102 and connected to one or more of the blades 106. The electric motor can be powered by a battery or by an external power source supplied via cable 110 for example. A level adjustment lever 108 can be used to control the opening of blades 106 for tapering. Various guards can be attached to the blade assembly in order to further control the length of hair to be cut by the clipper blades.

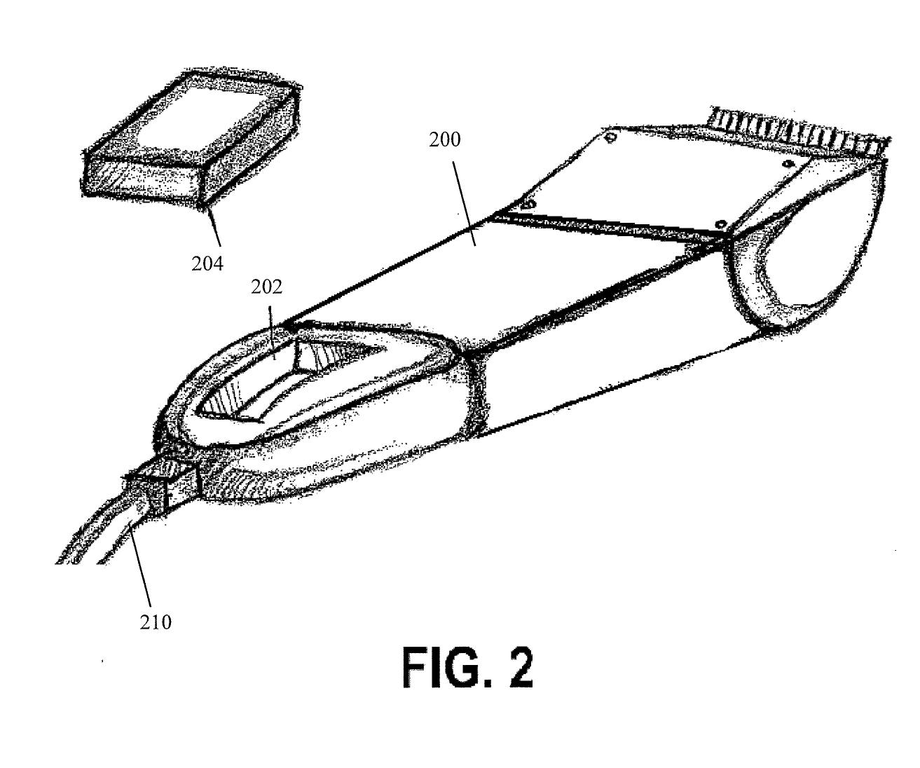

FIG. 2 illustrates an exemplary electric hair clipper 200 with adjustable weight according to examples of the disclosure. Electric hair clipper 200 can be designed to improve the user experience for a barber or stylist by allowing the barber or stylist to configure electric hair clipper 200 to have a desired weight, which can improve comfort and performance during a haircut. The housing of hair clipper 200 can include recess 202 configured to receive a removable weight 204. Weight 204 can be used to adjust the total weight and balance of hair clipper 200. Weight 204 can be made of metals, plastics, or any other suitable material or composite. The dimensions of weight 204 can be substantially the same as the dimensions of recess 202. Although recess 202 is illustrated in FIG. 2 as a rectangular opening, recess 202 and therefore weight 204 for be other shapes (e.g., circular, square, triangle, polygon). A clipper can be provided with any number of weights, each weight having the same dimensions but a different weight (i.e. different mass), to allow the barber to select the appropriate weight 204 based on the preferred total weight and balance. In some examples, weights can range from 10 grams to 50 grams, though other weights can be selected based on the desired weight and balance. In other examples, the weights can range from 25 grams to 250 grams. In some examples, the weights can be labeled so that the user can select the desired weight. Recess 202 can also remain empty if no additional weighting is desired.

In some examples, the weight can be inserted into the recess 202 of hair clipper 200 and a cover (not shown) can be used to secure the weight in place. In other examples, the weight can have a depressible portion (not shown) which can be depressed to insert weight 204 into recess 202 and can be released to secure weight 204 within recess 202. In other examples, weight 204 and portions of the housing proximate to or at recess 202 can be made of materials to secure the weight in place using magnetic properties. For example, weight 204 can be made of a magnetic substance such that it can be inserted into recess 202 without using a cover. The housing of hair clipper 200 can be designed to include suitable material at or proximate to recess 202 to couple with the magnetic weight (e.g., metal or magnetic material). In other examples, weight 204 can be metal and the housing at or proximate to recess 202 can be magnetic or include some magnetic materials. A magnetic effect coupling weight 204 to clipper 200 can provide easy access to adjust the total weight and balance of hair clipper 200 without having to remove a cover.

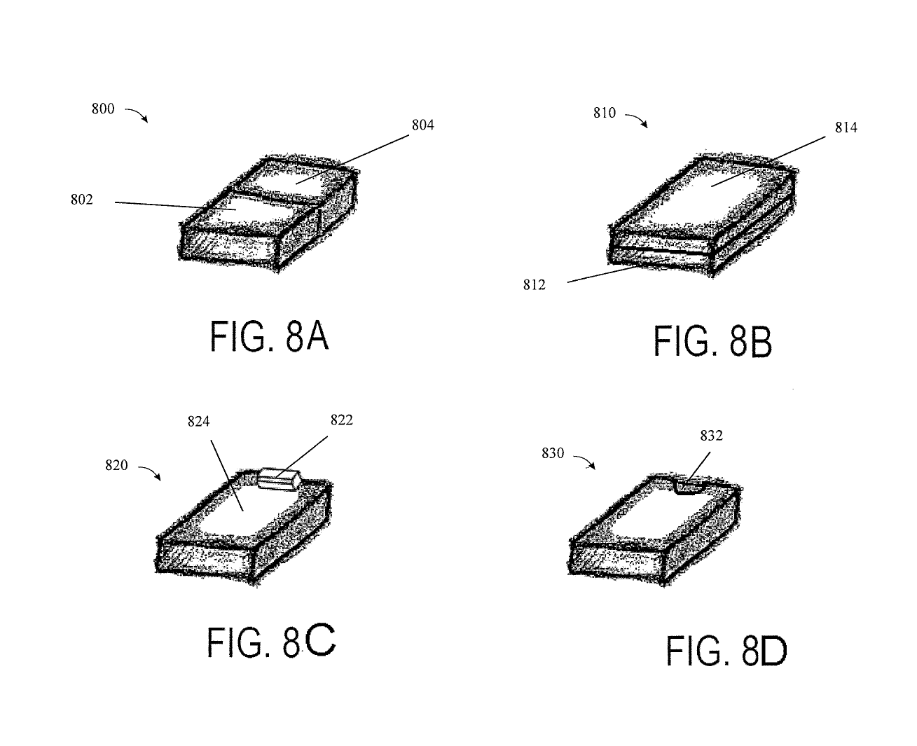

In some examples, two or more weights can be magnetically coupled to form a composite weight of substantially the same dimensions as recess 202. FIGS. 8A and 8B illustrate exemplary composite weights 800 and 810 according to examples of the disclosure. As illustrated in FIG. 8A, composite weight 800 can be formed from two component weights 802 and 804 coupled together, for example, although composite weight 800 can be formed of more than two component weights. Additionally, although FIG. 8A illustrates the component weights 802 and 804 in a side-by-side configuration, as illustrated in FIG. 8B, composite weight 810 can include two or more component weights 812 and 814 stacked on top of one another. Other configurations can also be used, including inserting a component weight with a recess, e.g., a first weight having dimensions substantially the same can have a recess or hole to insert a second weight, in which to insert a second component weight. The weight of component weights 802 and 804 (or similarly 812 and 814) can be the same (e.g., 10 grams each) or different weights (e.g., 10 grams and 20 grams), such that various total weights for composite weights 800 and 810 can be formed.

In order to improve accessibility for inserting and removing weight 204 from recess 202, the weight 204 can include a protrusion. FIG. 8C illustrates an exemplary weight 820 with a protrusion 822 according to examples of the disclosure. Protrusion 822 can be located at an end of weight 820 as illustrated in FIG. 8C, or it can be located on any other portion of the surface of weight 820 which is not in contact with recess 202. For example, the protrusion can be located in the center of the surface 824. A user can use protrusion 822 to release the weight from the recess of the clipper. In some examples the protrusion can be formed from the same material as the weight although in other examples, it can be made of a different material. Protrusion 822 can also include a grove into which a fingernail or finger can fit to provide for improved leverage. Although illustrated as having a substantially rectangular shape, the protrusion can have other shapes including a square, half circle or ellipse, for example. Other protrusions or tabs can also be used to improve accessibility.

In other examples, one or more depressions in the weight 204 can be used to improved accessibility for inserting or removing weight 204. FIG. 8D illustrates an exemplary weight 830 with a depression 832 according to examples of the disclosure. Although only a single depression 832 is shown, there can be additional depressions to improve accessibility. For example, a pair of depressions can be made on opposite ends of a surface of weight 830 to allow a user to “pinch” the weight by inserting a portion of a finger in each depression. In other examples, additionally or alternatively, the recess of the clipper can include a one or more depressions at edges to provide access for inserting and removing weight 830. Thus the one or more depressions can permit access to a portion of a finger to help insert or remove the weight.

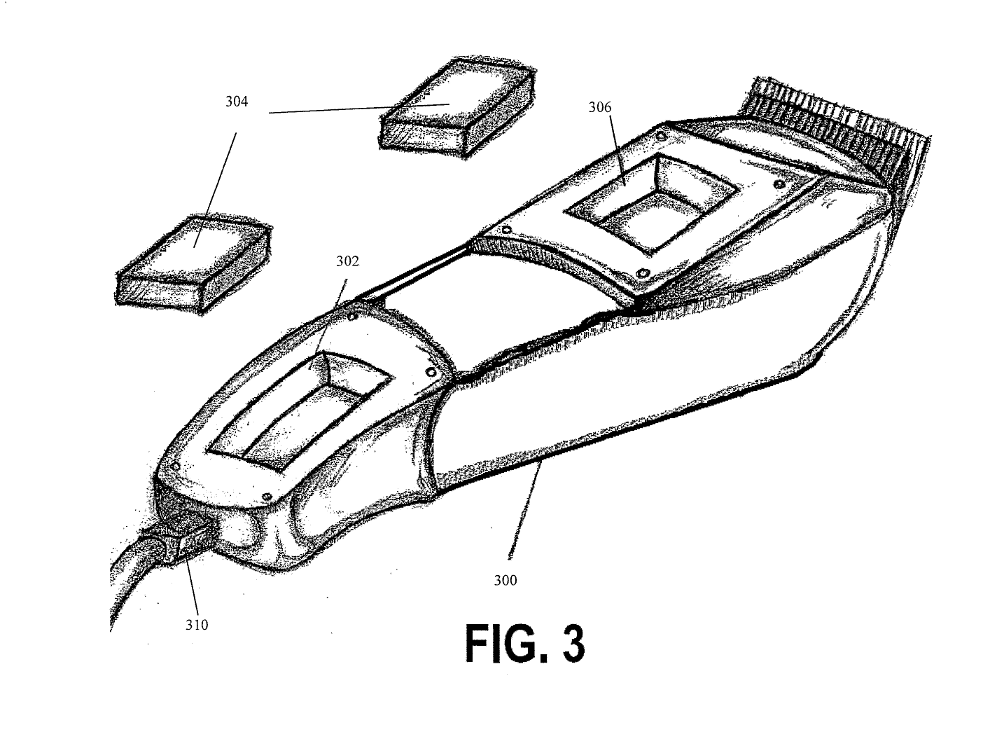

As illustrated in FIG. 2, hair clipper 200 can have a single recess 202 in the portion of the housing proximate to power cord 210. In other examples, there can be more than one recess into which a weight can be inserted, and the recess can be located at different portions of hair clipper 200. FIG. 3 illustrates an exemplary electric hair clipper with multiple adjustable weights according to examples of the disclosure. Hair clipper 300 can have two or more recesses 302, 306 into which weights 304 can be inserted. As discussed above with respect to FIG. 2, weights 304 can have dimensions substantially matching the dimensions of recesses 302 and 306. In some examples, recess 302 and 306 can have the same dimensions, but in other examples, recesses 302 and 306 can be of different dimensions. Weights 304 can have the same or different weight and may be selected from among a number of weights as discussed above. The various weights can allow the barber to select the appropriate weights 304 based on the preferred total weight and balance between the forward and rear portions of clipper 200. In some examples, specific weights can be recommended based on the preferences of the user. For example, the clipper can include instructions that provide weight suggestions, so that the clipper can approximate the total weight and balance of other clipper models the barber typically uses. Although FIG. 3 illustrates recess 302 in the portion of the housing proximate to the power cord and recess 306 in the portion of the housing proximate to the blades, recesses 302 and 306 can be located in other portions of the housing. For example, recesses can be located on the top, bottom or the sides depending on the desired locations of the weights. In some examples, recesses can be located on opposite sides of hair clipper 300 (e.g., not on the top or bottom) in order to add weight without upsetting the balance to the left or right.

The weights can be made of different materials. For example, magnetic weights can include ferromagnetic materials such as cobalt, iron or nickel or alloys including aluminum, cobalt, iron or nickel. Magnetic weights can also include ferrites, although other magnetic materials are possible. Additionally, in examples using a cover, the weights can be made of other magnetic or non-magnetic materials such as metals, plastics, and other suitable materials.

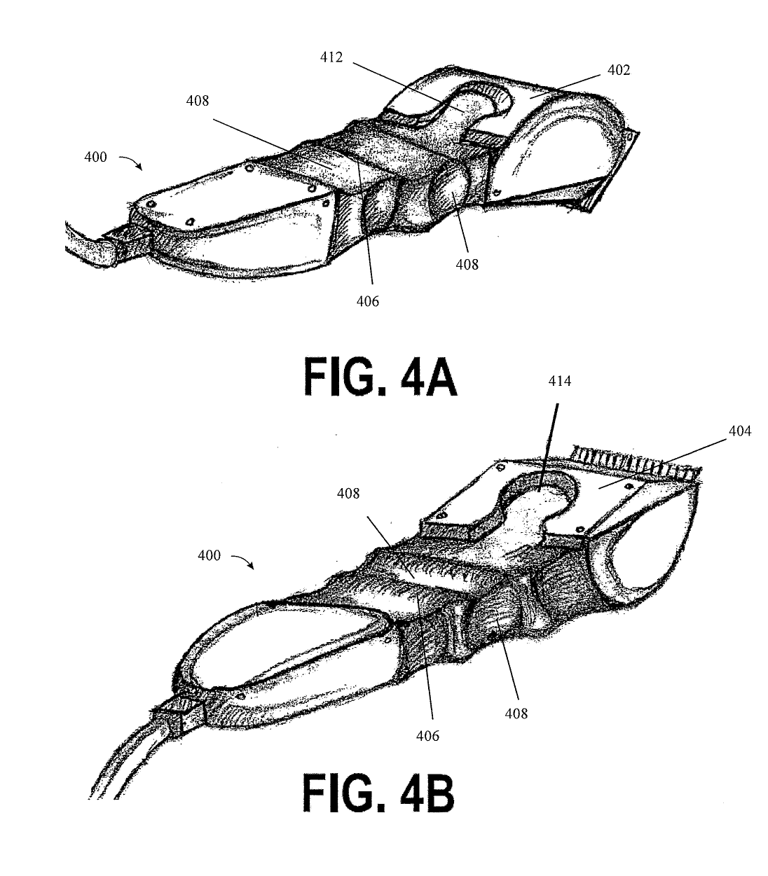

In other examples, the electric clippers can be designed to improve the user experience for a barber or stylist by designing the housing to include improved grips for hands and fingers. FIGS. 4A and 4B illustrate exemplary views of an electric hair clipper 400 with hand and finger grips according to examples of the disclosure. FIG. 4A illustrates a bottom view and FIG. 4B illustrates a top view of clipper 400 with improved hand and finger grips. Portion 402 of the housing on the underside of clipper 400 can include a groove 412 configured to receive a finger. Similarly, portion 404 of the housing on the top side of clipper 400 can include a groove 414 configured to receive a finger. Grooves 412 and 414 can provide a resting place for a finger, e.g., a thumb, in order to secure the barber's grip on clipper 400. The improved grip can help control clipper 400 during fine cutting activities, such as trimming around a customer's ears or for fades. In some examples, the housing of clipper 400 can be plastic and portions 402 and 404 can be formed with grooves 412 and 414. In other examples, portions 412 or 414 can be separate pieces of plastic formed with a groove or having a groove cut therefrom and the separate pieces of plastic can be coupled to the clipper housing (e.g., via epoxy or screws).

Grooves 412 and 414 can be located between the blades and the hand grip of the clippers to provide accurate control and be in a natural position for a hand gripping the clipper. Thus, as illustrated in FIGS. 4A and 4B, the grooves are located just above the hand grip in the lower section of portions 402 and 404 of the housing. Grooves 412 and 414 can have a shape that follows the shape of a finger, such as a thumb. For example, as illustrated in FIGS. 4A and 4B, grooves 412 and 414 can be rounded to accommodate the shape of a thumb and can narrow as the groove moves toward the hand grip in order to secure the thumb in place. Additionally, grooves 412 and 414 can be made deep enough to reasonably secure the thumb in place.

Additionally, as illustrated in FIGS. 4A and 4B, the central portion of the clipper 400 can be formed as a hand grip or to include a hand grip. The hand grip can be formed of plastic or rubber. For example, the rubber can be flexible, standard or high temperature polyvinyl chloride (PVC), PVC vinyl closed-cell foam, foam rubber, isoprene, low density polyethylene (LDPE), linear low-density polyethylene (L-LDPE), high density polyethylene (HDPE), polypropylene (PE), silicone rubber, styrene-ethylene/butylene-styrene (SEBS) or styrene-ethylene/propylene-styrene (SEPS). In some examples, a rubber layer can be formed over a plastic layer. A rubber hand grip can help ensure the clipper does not slip in the barber's hand while the barber operates the clipper 400. The hand grip can be formed with a textured, ribbed or convoluted surface for additional grip. The ribbed structure can include ridges 406 separating the hand grip into a number of valleys 408 which can provide space for a barber's fingers for a secure grip. The ridges 406 and valleys 408 can wrap around the middle portion of clipper 400, such that it covers the top, bottom, and sides of clipper 400. Using a ribbed grip can provide a housing with a thinner profile in additional to a stable grip. The hand grip made of rubber can also provide insulation which can reduce discomfort associated with heat from the operation of the clipper motor. In some examples the ribbed structure of the hand grip can be a single piece of rubber, but in other examples, the rubbed structure can be formed of several pieces or modules.

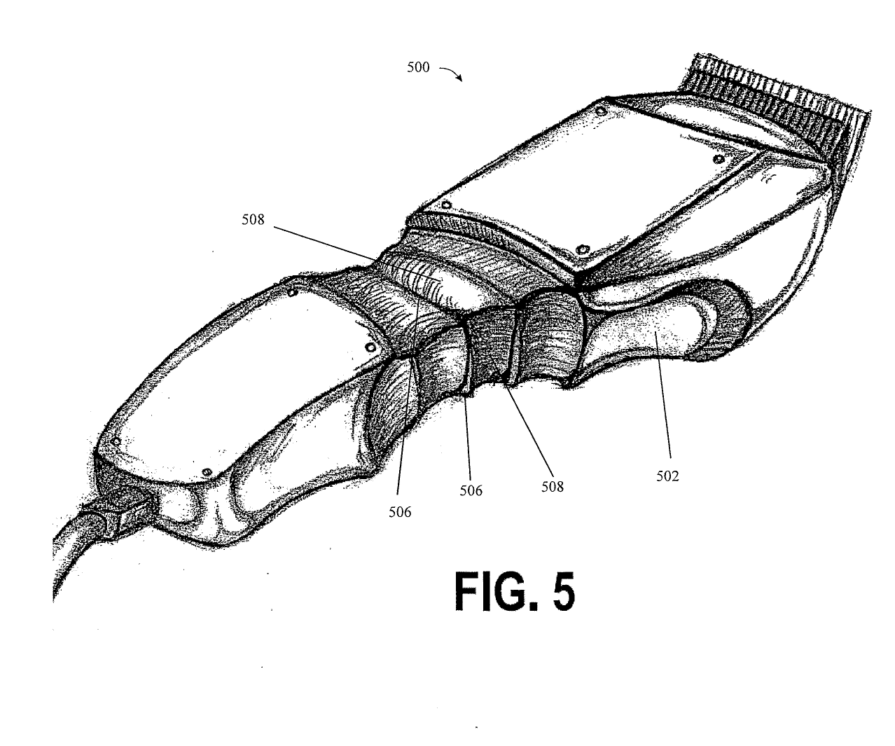

FIG. 5 illustrates an exemplary electric hair clipper 500 with a hand grip and thumb rest according to examples of the disclosure. Electric clipper 500 can have a rubber hand grip area with a ribbed structure including ridges 506 separating the hand grip into a number of valleys 508 which can provide space for a barber's fingers for a secure grip. Additionally, the housing of the electric clipper 500 can include thumb rest 502 between the hand grip and the blades. Thumb rest 502 can have a plastic surface or a rubber surface made from the same or a similar material as the surface of the hand grip. Thumb rest 502 can be located on the side of the housing so that a barber holding the electric clipper 500 by the hand grip can naturally place the thumb at thumb rest 502 for a secure and comfortable grip.

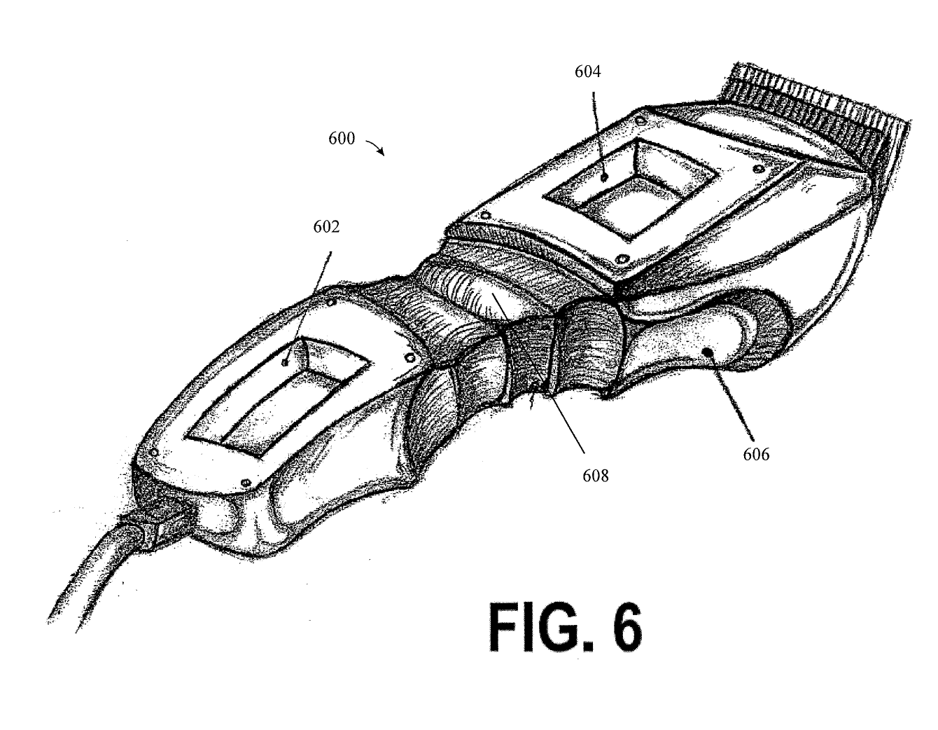

Although the features of FIG. 2-5 are illustrated separately, in some examples, the features can be combined. Thus, a hair clipper can be configured to have one or more adjustable weights and various hand grips and finger rests. FIG. 6 illustrates an exemplary electric hair clipper 600 according to examples of the disclosure. As illustrated in FIG. 6, the electric hair clipper 600 can have two or more recesses 602, 604 (e.g., similar to recesses 302, 306) into which weights can be inserted. Electric hair clipper 600 can also have a thumb rest 606 (e.g., similar to thumb rest 502) and a hand grip 608 (e.g., similar to the hand grip described above with respect to FIG. 5).

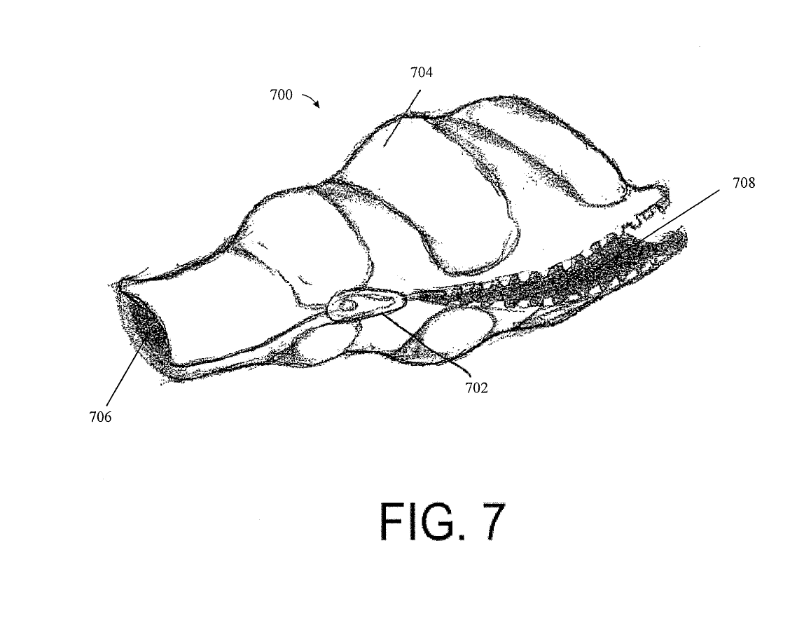

In other examples, a removable sleeve can be designed for use with electric hair clippers to mitigate the effects of vibrations and heat. Electric hair clippers can become hot to the touch after continued use, causing discomfort and preventing a barber from continuously using the clippers for extended periods of time necessary to complete a series of haircuts. Vibrations due to the electric motor can cause discomfort and reduce the quality of a haircut. FIG. 7 illustrates and exemplary removable clipper sleeve according to examples of the disclosure. Sleeve 700 can be constructed from elastic materials so that it can snuggly fit around clippers of varying size. For example, sleeve 700 can be made of neoprene, nylon or quilted fabric. The inner surface 708 of sleeve 700 can be made of a no-slip material (e.g., coating the interior with rubber or silicone skids) such that sleeve 700 can be secured to the electric clipper. The exterior surface of sleeve 700 can be made of a soft, no-slip material so that the sleeve can be held comfortably and securely by the barber. The material forming sleeve 700 or a coating of the sleeve can be thermally insulating to protect the barber's hand from heat generated by the electric clipper.

Sleeve 700 can have opening 706 at its base to accommodate the power cord of an electric clipper. Zipper 702 can be used to secure sleeve 700 around the electric clipper, although other ways of securing the sleeve around the electric clipper are possible. Similarly, zipper 702 can provide an easy means to remove sleeve 700 from around the electric clipper.

Sleeve 700 can include gel packs 704 to minimize the vibration of the electric clipper. In some examples, sleeve 700 can include spaces (e.g., pouches) in which to insert gel packs 704. In some examples, the pouches can include an opening on the interior surface of sleeve 700. The openings can be used to insert gel packs 704 into the pouches. In some examples, the opening can be sealed after manufacture of sleeve 700. In other examples, the opening can remain open or otherwise accessible so that gel packs 704 can be removed and replaced as necessary due to wear. The gel contained in gel pack 704 can be a liquid gel, but in other examples, gel packs 704 can be formed of or contain solid or semi-solid gel materials.

Although examples of this disclosure have been fully described with reference to the accompanying drawings, it is to be noted that various changes and modifications will become apparent to those skilled in the art. Such changes and modifications are to be understood as being included within the scope of examples of this disclosure as defined by the appended claims.

What is claimed is:

1. A hair cutting apparatus, the apparatus comprising:
a housing comprising one or more recesses formed therein, wherein the one or more recesses are configured to receive a weight;
a motor disposed within the housing; and
one or more blades located at a distal portion of the housing, the one or more blades connected to the motor.

2. The hair cutting apparatus of claim 1, wherein the hair cutting apparatus further comprises a power cord, and wherein a recess of the one or more recesses is located in a proximal portion of the housing proximate to the power cord.

3. The hair cutting apparatus of claim 1, wherein a recess of the one or more recesses is located at the distal portion of the housing.

4. The hair cutting apparatus of claim 1, wherein the weight is formed at least partially of a magnetic substance, and wherein the housing comprises a magnetic substance configured to magnetically couple to the weight located proximate to or at the surface of the one or more recesses.

5. The hair cutting apparatus of claim 1, wherein the housing comprises one or more removable covers over the one or more recesses configured to secure the weight.

6. A hair cutting apparatus, the apparatus comprising:
a housing having one or more grooves formed therein as finger rests;
a motor located inside the housing; and
one or more blades coupled to the motor, the one or more blades located at a distal portion of the housing.

7. The apparatus of claim 6, wherein the housing has at least two grooves formed therein and located on opposite sides of the apparatus.

8. The apparatus of claim 6, wherein the housing has at least two grooves formed therein and located on the top and bottom of the apparatus.

9. The apparatus of claim 6, wherein rubber material is disposed on the surface of the housing over the one or more grooves.

10. The apparatus of claim 6, wherein a middle portion of the housing includes one or more ridges and a plurality of valleys.

11. The apparatus of claim 10, wherein the middle portion is formed at least partially of a rubber material.

12. A removable sleeve for a hair cutting tool, comprising:
a body comprising an exterior surface and an interior surface, the interior surface configured for contacting an exterior of a housing of the hair cutting tool; and
a zipper coupled to the body and configured to increase an area of the interior surface of the body in contact with the exterior of the housing of the hair cutting tool in a closed position and decrease the area of the interior surface of the body in contact with the exterior of the housing in an open position.

13. The removable sleeve of claim 12, wherein the body of the sleeve is formed of elastic material.

14. The removable sleeve of claim 12, wherein the interior surface of the sleeve is made of a rubber material.

15. The removable sleeve of claim 12, wherein when the zipper is in the closed position, the body comprises at least one opening for a blade assembly of the hair cutting tool, the at least one opening circumscribing the housing of the hair cutting tool.

16. The removable sleeve of claim 12, wherein the body comprises at least one opening for a power cord.

17. The removable sleeve of claim 12, wherein the sleeve comprises one or more pouches for receiving gel packs.

18. The removable sleeve of claim 17, wherein the one or more pouches have an opening for removing or replacing a gel pack.
